(19) United States
(12) Patent Application Publication
(10) Pub. No.: US 2017/0087598 A1
(43) Pub. Date: Mar. 30, 2017

(54) TWO-SIDED CLEANING IMPLEMENT

(71) Applicant: Michael OBOLEY, Colorado Springs, CO (US)

(72) Inventor: Michael OBOLEY, Colorado Springs, CO (US)

(21) Appl. No.: 15/282,514

(22) Filed: Sep. 30, 2016

Related U.S. Application Data
(60) Provisional application No. 62/234,752, filed on Sep. 30, 2015.

(51) Int. Cl. B08B 1/00; A47K 7/03; A47L 13/19

(52) U.S. Cl. CPC B08B 1/006; A47L 13/19; A47K 7/03

(57) ABSTRACT

A moistened wipe that has a first moistened sheet, having a top surface, a bottom surface, a first side, a second side, a third side, and a fourth side; and a second moistened sheet, having a top surface, a bottom surface, a first side, a second side, a third side, and a fourth side, wherein the top surface of the first side, second side and third side of the second moistened sheet are adhered to the bottom surface of the first side, second side and third side, respectively, of the first moistened sheet and the fourth side of the first moistened sheet and the fourth side of the second sheet are unattached, forming an opening between the first moistened sheet and the second moistened sheet.

### RELATED APPLICATIONS

This application claims priority to U.S. Provisional Application Ser. No. 62/234,752, titled TWO-SIDED CLEANING IMPLEMENT, filed on Sep. 30, 2015, the entire contents of which are incorporated by reference herein.

### BACKGROUND

Embodiments of the invention generally relate to cleaning implements. Existing baby wipes take the form of a single moistened sheet of fabric. Generally, only one side of the baby wipe is used. Once one side of the sheet has been used, it is difficult to use the other side of the sheet and to dispose of the sheet while also avoiding excrement on one's hands. Single sheet cleaning wipes have the same problem.

### SUMMARY

In some embodiments, the present disclosure relates to a double-sided, moistened wipe. In some embodiments, the double-sided wipe can include a first moistened sheet, having a top surface, a bottom surface, a first side, a second side, a third side, and a fourth side; and a second moistened sheet, having a top surface, a bottom surface, a first side, a second side, a third side, and a fourth side, wherein the top surface of the first side, second side and third side of the second moistened sheet are adhered to the bottom surface of the first side, second side and third side, respectively, of the first moistened sheet and the fourth side of the first moistened sheet and the fourth side of the second sheet are unattached, forming a pocket between the first moistened sheet and the second moistened sheet. In some embodiments, only the top surface of the first moistened sheet is moistened, while the bottom surface of the first moistened sheet is not. In some embodiments, only the bottom surface of the second moistened sheet is moistened, while the top surface of the second moistened sheet is not.

In some embodiments, the double-sided wipe can include a single sheet of fabric, folded back on itself to form a top sheet and a bottom sheet, the top sheet and the bottom sheet adhered to each other on two sides, forming a pocket between the top sheet and the bottom sheet, wherein the exterior surfaces of double sided wipe are moistened, while the interior surface of the wipe, e.g., the surfaces inside the pocket, are not moistened.

In some embodiments, the wipe is double-sided. In some embodiments, the wipe is reversible. In some embodiments, the opening forms a pocket. In some embodiments, each of the moistened sheets comprises fabric. In some embodiments, each of the moistened sheets comprises a woven material. In some embodiments, each of the moistened sheets comprises felt. In some embodiments, the moistened sheets are adhered with tape. In some embodiments, the moistened sheets are adhered with glue. In some embodiments, the top surface of the first moistened sheet is moistened and the bottom surface is not moistened. In some embodiments, the bottom surface of the second moistened sheet is moistened and the top surface is not moistened. In some embodiments, the top surface of the first moistened sheet and the bottom surface of the second moistened sheet also comprise a cleaning solution. In some embodiments, the moistened wipe is sized to fit over a human hand. In some embodiments, the moistened wipe is further sized to cover at least a portion of a human forearm. In some embodiments, each of the first side, the second side, the third side, and the fourth side of the first moistened sheet, and each of the first side, the second side, the third side, and the fourth side of the second moistened sheet comprise a straight side.

### BRIEF DESCRIPTION OF DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention.

FIG. 1 is a perspective view of a double-sided wipe, according to some embodiments of the present disclosure.

FIG. 2 is a cross-sectional side view of the double-sided wipe, according to some embodiments of the present disclosure.

FIG. 3 is a flow chart of a method for making the double-sided wipe, according to some embodiments of the present disclosure.

FIG. 4 is a flow chart of a method for using double-sided wipe, according to some embodiments of the present disclosure.

FIG. 5 illustrates a side perspective view of a double-sided wipe applied to a hand of a user, according to some embodiments of the present disclosure.

FIG. 6 illustrates a top plan view of the double-sided wipe of FIG. 5 as applied to a hand of a user, according to some embodiments of the present disclosure.

### DESCRIPTION

The present disclosure relates to a double sided, moistened wipe. The wipe is comprised of a fabric sheet folded back onto itself and sealed on two sides to create a pocket. The pocket can be approximately the size of hand. The outside surfaces of the wipe can be moistened with cleaning solution or moisturizing solution. In some embodiments, all surfaces of the wipe can be moistened. Each of the outside surfaces of the wipe can be used to clean a surface, a baby's bottom, or another object that needs cleaned or moistened. Once one or both sides of the wipe are used, the wipe can be turned inside out and disposed of appropriately. Because the wipe can be turned inside out, for example as the wipe is removed from the user's hand, the user's hand does not come into contact with dirt or excrement.

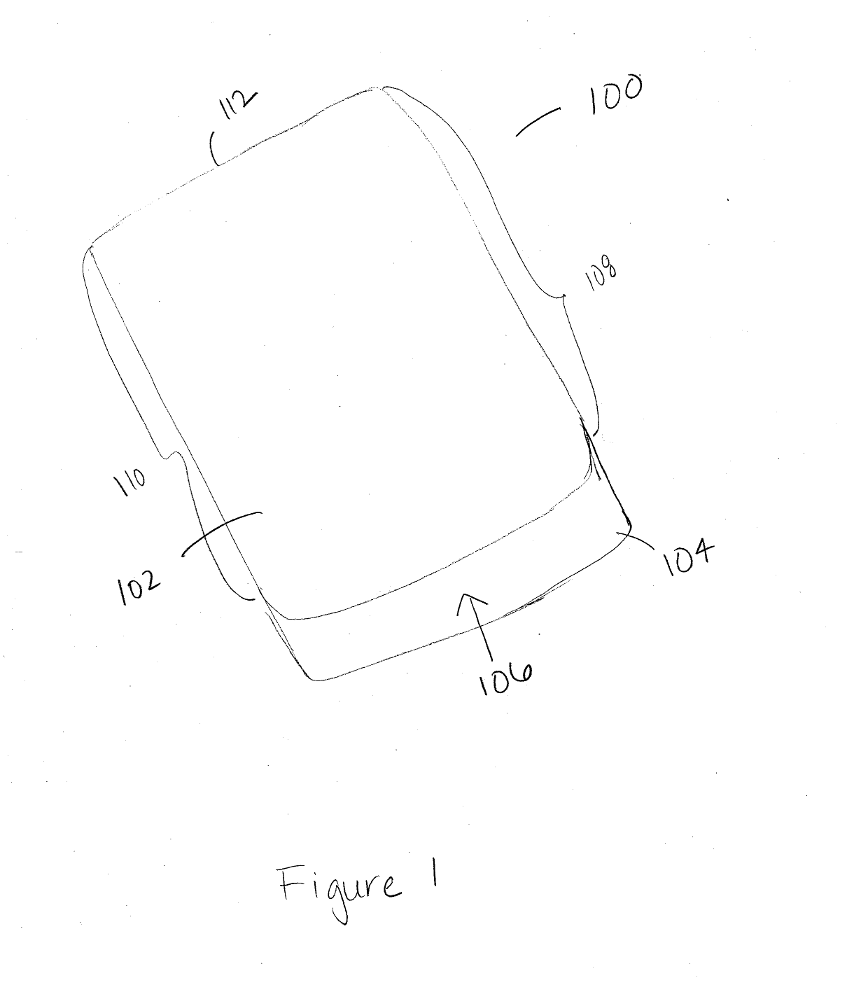

FIG. 1 is a perspective view of a double-sided wipe, according to some embodiments of the present disclosure. Double-sided wipe 100 includes a bottom layer 104, a top layer 102, and an opening 106. In some embodiments, bottom layer 104 and top layer 102 can be made from a continuous sheet of material folded back onto itself. In some embodiments, bottom layer 104 and top layer 102 are made from two separate sheets of material. In some embodiments, top layer 102 is shorter than bottom layer 104. However, in other embodiments, top layer 102 can be the same dimension or longer than bottom layer 104. Top layer 102 and bottom layer 104 can be made from fabrics, woven and unwoven, or felts, or other material or combination of materials capable of being formed in one or more layers and/or optionally capable of accepting a cleaner, moistener, and/or fluid. In some embodiments, top layer 102 and bottom layer 104 can be formed or layered to produce a thin sheet of material (e.g., one ply and/or thin material) or a thick sheet of material (e.g., two or more ply and/or thick material).

The exterior surfaces of both top layer 102 and bottom layer 104 are coated or moistened with a cleaning solution. The cleaning solution may be a general household cleaner for cleaning household surfaces. In some embodiments, the cleaning solution can also be a moisturizer and cleaner for wiping babies during diaper changes, or for wiping pets. In some embodiments, the inner surfaces of the pocket remain un-moistened and dry. In other embodiments, all surfaces of the wipe, including the inner surfaces of the pocket, can be moistened.

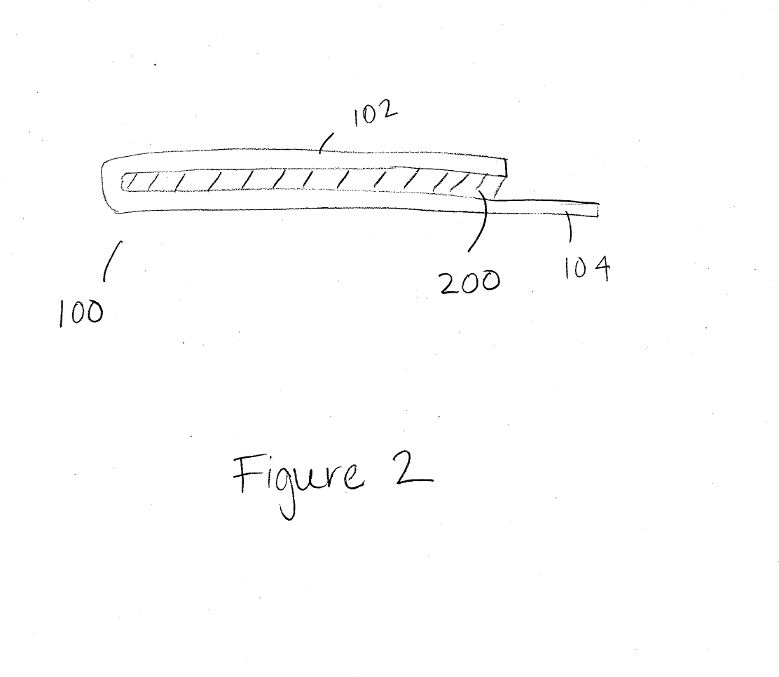

Top layer 102 and bottom layer 104 can be adhered to each other along first side 110 and second side 108. In the two sheet embodiment, top layer 102 and bottom layer 104 are also adhered along third side 112. As described in more detail below in the description accompanying FIG. 2, the first side 110, second side 108, and third side 112 can be straight or curved. In some embodiments, a straight sided top layer 102 and bottom layer 104 are less expensive to manufacture.

In some embodiments, bottom layer 106 is longer than top layer 102 such that a portion of bottom layer 106 near the opening 104 extends further than top layer 102 and is not attached to top layer 102 (e.g., as shown in FIG. 1). The extended portion of bottom layer 106 can facilitate removal of the double-sided wipe without a user having to touch an exterior surface of either the bottom layer 106 or the top layer 102. In some embodiments, the length of both the top layer 102 and bottom layer 106 is sufficiently long to cover a portion of a user's forearm. With the additional length, a portion of the exterior surface is not exposed to a substance to be cleaned, such as dirt or excrement, for example. As described above, an advantage of not having to touch an exterior surface is to keep a user's hands cleaner when disposing of the double-sided wipe.

FIG. 2 is a cross section, side view of the double-sided wipe, according to some embodiments of the present disclosure. An adhesive 200 is disposed between top layer 102 and bottom layer 104. FIG. 2 depicts an embodiment where top layer 102 and bottom layer 104 are formed from the same sheet and only first side 110 and second side 108 need to be adhered to form pocket 106. Adhesive 200 can be any type of material for adhering two pieces of fabric, for example, tape or glue. In some embodiments, adhesive 200 can be water soluble. In some embodiments, adhesive 200 can be applied using a heat transfer method, e.g., through the use of an iron.

Double sided wipe 100 can be any dimension to fit over a human hand. For example, double sided wipe 100 can be sized in extra-small, small, medium, large and extra-large sizes. In some embodiments, a plurality of the described double-sided wipes can be stacked and packaged within a storage container. Also, while double sided wipe 100 is illustrated as being square or rectangular, one of ordinary skill in the art will appreciate, based on the present disclosure, that wipe 100 may include a perimeter having any number of shapes, including oval, polygonal, triangular, or irregular shapes. When wipe 100 includes a perimeter of a different shape, references herein to “side” or “sides” will be understood to refer to the portions of such perimeter which, when placed onto the user's hand, correspond to the top, bottom, first side, and second side of the user's hand.

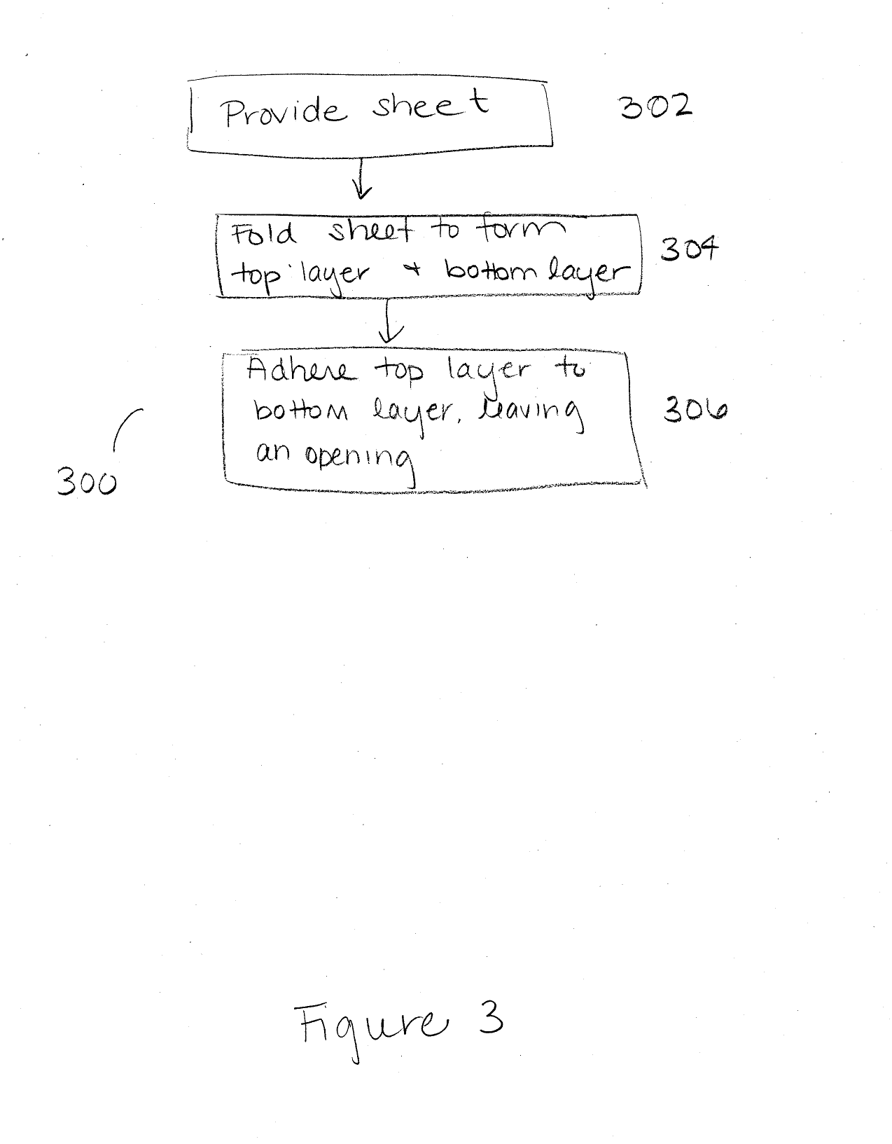

FIG. 3 is a flow chart of a method for making the double-sided wipe 300, according to some embodiments of the present disclosure. In some embodiments, the method can include providing a sheet (302), folding the sheet to form a top layer and a bottom layer (304), and adhering the top layer to the bottom layer, leaving an opening (306).

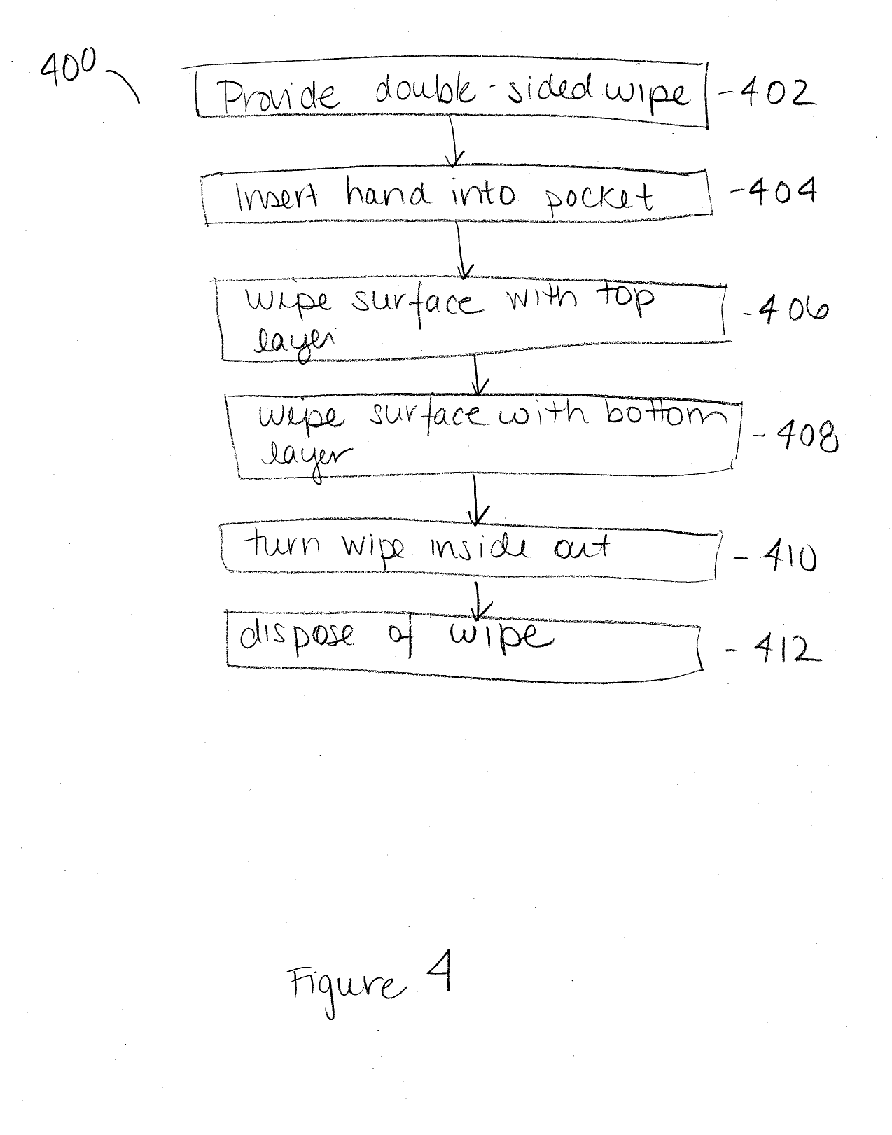

FIG. 4 is a flow chart of a method for using double-sided wipe 400, according to some embodiments of the present disclosure. In some embodiments, the method includes providing a double-sided wipe (402), inserting a hand into the pocket of the double-sided wipe (404), wiping a surface to be cleaned with a top layer of the double-sided wipe (406) wipe the surface with a bottom layer (408), turn double-sided wipe inside out (410), dispose of wipe (412).

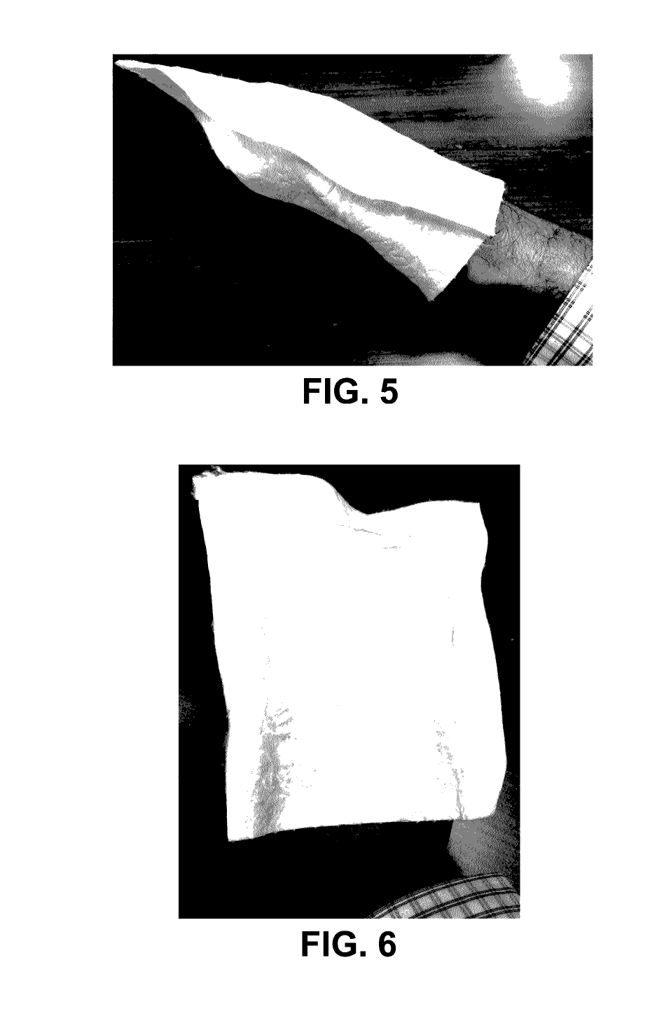

FIG. 5 illustrates a side perspective view of a double-sided wipe applied to a hand of a user, according to some embodiments of the present disclosure.

FIG. 6 illustrates a top plan view of the double-sided wipe of FIG. 5 as applied to a hand of a user, according to some embodiments of the present disclosure.

The present disclosure has been described in considerable detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

1. A moistened wipe, comprising
a first moistened sheet, having a top surface, a bottom surface, a first side, a second side, a third side, and a fourth side; and
a second moistened sheet, having a top surface, a bottom surface, a first side, a second side, a third side, and a fourth side, wherein the top surface of the first side, second side and third side of the second moistened sheet are adhered to the bottom surface of the first side, second side and third side, respectively, of the first moistened sheet and the fourth side of the first moistened sheet and the fourth side of the second sheet are unattached, forming an opening between the first moistened sheet and the second moistened sheet.

2. The moistened wipe of claim 1, wherein the wipe is double-sided.

3. The moistened wipe of claim 1, wherein the wipe is reversible.

4. The moistened wipe of claim 1, wherein the opening forms a pocket.

5. The moistened wipe of claim 1, wherein each of the moistened sheets comprises fabric.

6. The moistened wipe of claim 1, wherein each of the moistened sheets comprises a woven material.

7. The moistened wipe of claim 1, wherein each of the moistened sheets comprises felt.

8. The moistened wipe of claim 1, wherein the moistened sheets are adhered with tape.

9. The moistened wipe of claim 1, wherein the moistened sheets are adhered with glue.

10. The moistened wipe of claim 1, wherein the top surface of the first moistened sheet is moistened and the bottom surface is not moistened.

11. The moistened wipe of claim 1, wherein the bottom surface of the second moistened sheet is moistened and the top surface is not moistened.

12. The moistened wipe of claim 1, wherein the top surface of the first moistened sheet and the bottom surface of the second moistened sheet also comprise a cleaning solution.

13. The moistened wipe of claim 1, wherein the moistened wipe is sized to fit over a human hand.

14. The moistened wipe of claim 13, wherein the moistened wipe is further sized to cover at least a portion of a human forearm.

15. The moistened wipe of claim 1, wherein each of the first side, the second side, the third side, and the fourth side of the first moistened sheet, and each of the first side, the second side, the third side, and the fourth side of the second moistened sheet comprise a straight side.
